(19) United States
(12) Patent Application Publication
(10) Pub. No.: US 2025/0373975 A1
(43) Pub. Date: Dec. 4, 2025

(54) Open-ear Headphone

(71) Applicant: Anker Innovations Technology Co., Ltd., Changsha (CN)

(72) Inventor: Yu Xiao, Shenzhen (CN)

(21) Appl. No.: 19/213,503

(22) Filed: May 20, 2025

(30) Foreign Application Priority Data
May 29, 2024 (CN) 202421203810.2

(51) Int. Cl. H04R 1/28; H04R 1/10

(52) U.S. Cl. CPC H04R 1/2826; H04R 1/1008; H04R 1/1075; H04R 1/105; H04R 2460/11

(57) ABSTRACT

Disclosed is an open-ear headphone. The open-ear headphone may include a housing and a sound generation unit. The housing may comprise a mounting cavity, a tuning cavity provided next to the mounting cavity, a sound outlet hole, and a vent hole. The sound generation unit may partition the mounting cavity into a front cavity and a rear cavity. The sound outlet hole may communicate with the front cavity, and the vent hole may communicate with the tuning cavity. An air guiding gap may connect the rear cavity and the tuning cavity. Flow areas may be defined within the open-ear headphone.

### CROSS-REFERENCE TO RELATED APPLICATION

The present application claims priority to Chinese Patent Application No. 202421203810.2, filed on May 29, 2024, which may be herein incorporated by reference by its entirety.

### FIELD

The present disclosure relates to the technical field of headphones, such as an open-ear headphone.

### BACKGROUND

Many open-ear headphones adhere to the outer side of the ear canal and do not cover the ear canal. This approach may be taken because it may ensure that a consumer can listen to not only the sound from the headphones, but that the customer can also listen to sounds from an external environment. This may improve safety and comfort.

One issue with open-ear headphones and similar forms of open near-field listening methods may be that their design may cause a loss in the low-frequency part of the sound. For instance, an internal resonance space of the open-ear headphone may be insufficient to obtain an ideal sound quality.

### SUMMARY

Aspects described herein relate to an open-ear headphone having improved low-frequency performance.

The open-ear headphone provided in the example of the present disclosure may include a housing having a mounting cavity, a tuning cavity provided next to the mounting cavity, a sound outlet hole, and/or a vent hole. A sound generation unit may be provided in the mounting cavity and may partition the mounting cavity into a front cavity and a rear cavity, in which the sound outlet hole may communicate with the front cavity, and the vent hole may communicate with the tuning cavity. An air guiding gap may be further provided in the housing and may connect the rear cavity and the tuning cavity. A flow area may be formed at a part where the rear cavity and the air guiding gap are connected, and a flow area may be formed at a part where the tuning cavity and the air guiding gap are connected. Either or both flow areas may be larger than a flow area formed at the air guiding gap.

The housing of the open-ear headphone may be provided with the mounting cavity and the tuning cavity. The housing may comprise the sound outlet hole and the vent hole. The sound generation unit may partition the mounting cavity into the front cavity and the rear cavity. The sound outlet hole may communicate with the front cavity, and the venting hole may communicate with the tuning cavity. The air guiding gap may connect the tuning cavity and the rear cavity, and the flow area formed at a part where the rear cavity and the air guiding gap are connected and the flow area formed at a part where the tuning cavity and the air guiding gap are connected may individually or collectively be larger than the flow area formed at the air guiding gap, causing the air flowing through the air guiding gap to be compressed. When the sound generation unit vibrates to generate sound, the air in the rear cavity may be driven to vibrate, and since the vent hole may communicate with the tuning cavity, the air may flow along a path from the rear cavity to the air guiding gap to the tuning cavity, enabling all the air in the rear cavity and the tuning cavity to vibrate, which may increase a vibration mass, and the air may be compressed when flowing through the air guiding gap, which may increase air damping of vibration, thereby potentially increasing the equivalent air load, reducing the resonance frequency, causing an increase in low-frequency sound pressure level of the headphone, and/or improving the low-frequency performance of the open-ear headphone.

### BRIEF DESCRIPTION OF THE DRAWINGS

The accompanying drawings are briefly described below. These drawings are merely some examples of the present disclosure. Other drawings may be obtained based on the structures illustrated in these drawings.

FIG. 1 comprises an illustrative schematic diagram of a structure of an open-ear headphone;

FIG. 2 comprises an illustrative schematic diagram of a cross-sectional structure of an open-ear headphone;

FIG. 3 comprises an illustrative schematic diagram of a cross-sectional structure of an open-ear headphone; and

FIG. 4 comprises an illustrative schematic diagram of a cross-sectional structure of an open-ear headphone.

Description of reference numerals:
100: open-ear headphone; 100a: front-end portion; 100b: hook portion; 100c: rear-end portion; 10: housing: 10a: mounting cavity; 10b: tuning cavity; 10c: front cavity; 10d: rear cavity; 10e: air guiding gap; 101: sound outlet hole; 103: vent hole; 11: front housing; 111: front housing body; 113: front housing sealing cover; 1131: first wall surface; 115: second sealing cavity; 117: sound outlet boss; 13: rear housing;

131: rear housing body; 133: rear housing sealing cover; 1331: second wall surface; 135: first sealing cavity; 15: partition plate; 30: sound generation unit; 31: basket; 33: magnetic member; 35: vibration component; 351: voice coil; 353: diaphragm; 50: object to be sealed.

These drawings are further described below.

### DETAILED DESCRIPTION

Various examples of the present disclosure will be described in more detail below with reference to the accompanying drawings. In the following description regarding the drawings, the same numerals in different drawings may represent the same or similar elements. The examples described below are merely exemplary examples and do not represent all examples consistent with the present disclosure. Rather, the examples are merely examples of devices and methods that are consistent with some aspects of the present disclosure.

In the description of the present disclosure, the terms “first,” “second,” and the like are used for descriptive purposes only and should not be construed as indicating or implying relative importance. Unless otherwise specified, “multiple” may mean two or more. In addition, “and/or” may describe a relationship between associated objects, indicating that there may be three relationships. For example, A and/or B may indicate three cases: A alone, A and B at the same time, and B alone. The symbol “/” generally indicates that the relationship between the associated objects may be “or.”

The terms used in this description are for the purpose of describing examples and are not intended to limit the present disclosure. As used herein, the term “and/or” includes any and all combinations of one or more related listed items.

At present, an open-ear headphone product may be adhered to the outer side of the ear canal and might not cover the ear canal. This approach may ensure that a consumer can listen to not only the sound from the headphone but also the sound from the external environment, thereby improving safety and comfort. However, this approach may cause a serious loss in the low-frequency part of the sound, and an ideal sound quality might not be able to be obtained.

In order to improve the low-frequency sound performance of headphones and obtain a better listening effect, aspects described herein relate to an open-ear headphone 100. The open-ear headphone 100 has at least a wearing state, which may comprise a state in which the open-ear headphone 100 may be fitted to an ear of a user so as to be fixed relatively to the ear. In that wearing state, a user may obtain an ideal listening effect.

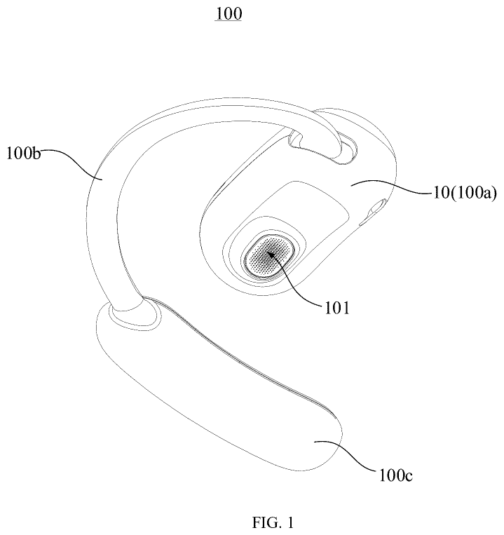

As illustrated in FIG. 1, the open-ear headphone 100 may include a rear-end portion 100c, a hook portion 100b, and/or a front-end portion 100a. The front-end portion 100a may be configured to adhere to the ear and produce a sound. The hook portion 100b may connect the front-end portion 100a and/or the rear-end portion 100c, and may be configured to hang between an upper side of the ear and the user's head in the wearing state. The rear-end portion 100c may be provided at an end of the hook portion 100b away from the front-end portion 100a, and may be configured to adhere between a rear side of the ear and the user's head in the wearing state. The hook portion 100b may be curved in an arc, and the hook portion 100b and the rear-end portion 100c may be at least in contact with front and rear sides of the ear to clamp the ear for fixing, so that the front-end portion 100a connected to an end of the hook portion 100b may be stably provided on a front side of the ear. The hook portion 100b and the rear-end portion 100c may have certain elasticity to allow the user to deform the hook portion 100b and/or the rear-end portion 100c to fit the fixing structure to the ear. For example, the hook portion 100b may be made of a titanium wire, a conductive wire, and/or soft silicone, and the rear-end portion 100c may be configured to install components such as batteries and circuit boards. When the open-ear headphone 100 may be worn to the ear, the front-end portion 100a may cover and/or might not extend into the opening of the ear canal. In this context, the term “cover” is used in a broad sense, as the front-end portion 100a may be in a position roughly corresponding to a position of the opening of the ear canal, but need not extend into the opening of the ear canal.

The front-end portion 100a, the hook portion 100b and/or the rear-end portion 100c may be three parts in detachable connection, and/or the front-end portion 100a, the hook portion 100b and/or the rear-end portion 100c may be a whole connected by a housing 10, and may be machine shaped together during processing.

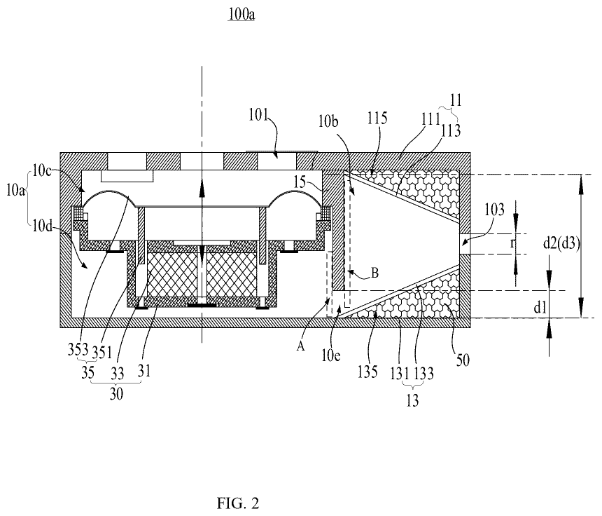

Referring to FIG. 2, the front-end portion 100a of the open-ear headphone 100 may include the housing 10, and a sound generation unit 30 may be provided in the housing 10.

Examples of the sound generation unit 30 may include, but are not limited to, electroacoustic conversion equipment such as a moving-coil loudspeaker, a moving iron loudspeaker, a micro-electro-mechanical system (MEMS) loudspeaker, a vibrator, and/or a planar loudspeaker.

An internal space of the housing 10 may include a mounting cavity 10a, an air guiding gap 10e, and/or a tuning cavity 10b. The tuning cavity 10b may be positioned next to the mounting cavity 10a, and the tuning cavity 10b may communicate with the mounting cavity 10a through the air guiding gap 10e. The sound generation unit 30 may be disposed in the mounting cavity 10a and may partition the mounting cavity 10a into a front cavity 10c and a rear cavity 10d. The housing 10 may be also provided with a sound outlet part and a pressure relief part. In the wearing state, the sound outlet part may be positioned on a side of the housing 10 facing the user's ear, and the pressure relief part may be positioned next to the sound outlet part, and/or on a side of the housing 10 away from the user's ear, and/or on a circumferential side of the housing 10. Specifically, the sound outlet part may be provided with a sound outlet hole 101 that may communicate with the front cavity 10c for transmitting sound waves. The pressure relief part may be provided with a vent hole 103 that communicates with the tuning cavity 10b so that air in the rear cavity 10d can enter the tuning cavity 10b and be discharged to the outside through the vent hole 103, thereby potentially preventing accumulation of pressure in the housing 10. Shapes of the vent hole 103 and the sound outlet hole 101 may be circular, square, strip-shaped, or the like, and are not limited by the examples of the present disclosure.

An air accommodating space of the air guiding gap 10e may be smaller than an air accommodating space of either of the rear cavity 10d and/or the tuning cavity 10b, and a flow area formed at a part A where the rear cavity 10d may be adjacent to the air guiding gap 10e and a flow area formed at a part B where the tuning cavity 10b may be adjacent to the air guiding gap 10e may be both larger than a flow area formed at the air guiding gap 10e.

The flow area may be a cross-sectional area on a plane perpendicular to an air flow direction that allows the air to pass through during flow of the air. In a structural form shown in FIG. 2, the air may flow along a path from the rear cavity 10d to the air guiding gap 10e to the tuning cavity 10b, and the plane perpendicular to the air flow direction may be a plane parallel to a thickness direction of the housing 10. In the plane parallel to the thickness direction of the housing 10, a width of the air guiding gap 10e may be smaller than a width of either of the rear cavity 10d and the tuning cavity 10b. In the case where the air guiding gap 10e, the rear cavity 10d, and the tuning cavity 10b have a uniform space distribution in other dimensional directions of the housing 10, the air flow area at the air guiding gap 10e may be the smallest, and the air accommodating space at the air guiding gap 10e may be smaller than the air accommodating space at either of the rear cavity 10d and the tuning cavity 10b, so that the air may be compressed when flowing through the air guiding gap 10e.

When the sound generation unit 30 vibrates to generate sound, the air in the rear cavity 10d may be driven to vibrate. Since the vent hole 103 in communication with the tuning cavity 10b may be far away from the sound generation unit 30, the air may flow through the air guiding gap 10e and the tuning cavity 10b, which may increase a volume of air participating in the vibration, that is, a mass of air increases.

According to formula:

$$f 0 = \frac{1}{2 π} \sqrt{\frac{1}{MmCm}} ,$$

where f0 may be a resonance frequency, and Mm may be a vibration mass. The mass of air participating in the vibration may increase, that is, the vibration mass Mm may increase, thereby reducing the resonance frequency f0, obtaining a resonance peak at a low frequency, thereby increasing the low-frequency sound pressure level of the headphone, and thereby improving the low-frequency performance of the open-ear headphone 100.

Regarding the air guiding gap 10e as a pipe communicating the mounting cavity 10a and the tuning cavity 10b, the flow area formed at a part A where the rear cavity 10d and may be adjacent to the air guiding gap 10e and the flow area formed at a part B where the tuning cavity 10b may be adjacent to and the air guiding gap 10e may be individually or both larger than the flow area formed at the air guiding gap 10e, and the air may be compressed when flowing through the air guiding gap 10e. Due to an end effect of the pipe, the air on both sides of the air guiding gap 10e may be subjected to additional disturbance and pressure gradient, which may increase an equivalent pipe length. Accordingly, the disturbance and oscillation of the air in the mounting cavity 10a and the tuning cavity 10b may be increased to affect a broader range, so that the sound generation unit 30 can drive all the air in the mounting cavity 10a and the tuning cavity 10b to vibrate. An equivalent air load may be the air mass or air resistance driven by a diaphragm of the sound generation unit 30 during vibration, and may reflect interaction between the sound generation unit 30 and the surrounding air. The greater the air resistance is, the greater the equivalent air load may be. The air may flow along a path from the rear cavity 10d to the air guiding gap 10e to the tuning cavity 10b, and may be compressed when flowing through the air guiding gap 10e, which may increase air damping of vibration, thereby potentially further increasing the equivalent air load of the sound generation unit 30, reducing the resonance frequency f0, and improving the low-frequency performance.

Referring to FIG. 2, in an example, in the thickness direction of the housing 10, the air guiding gap 10e may have a width d1, and the mounting cavity 10a may have a width d2, which may satisfy a relationship of d2≥1.2d1. In a structure in which the width of the mounting cavity 10a changes, the width d2 may take the minimum value among widths of the mounting cavity 10a to ensure that the widths of the mounting cavity 10a and the air guiding gap 10e satisfy the above relationship. If d2<1.2d1, that is, if the air guiding gap 10e changes less or remains the same compared to the width of the mounting cavity 10a, for example, d1=d2, the air might not be compressed when flowing through the air guiding gap 10e, and when the sound generation unit 30 vibrates to generate sound, the air in the mounting cavity 10a and the tuning cavity 10b might not be totally driven, so that there might not be an obvious increase in the vibration mass and no obvious improvement in the low-frequency performance. Therefore, in order to fully increase the air load, increase the vibration mass, and reduce the resonance frequency to obtain better low-frequency performance, d2≥1.2d1 may be used. d2 may be 1.5d1, 1.6d1, 2d1, 3d1, and the like.

Further, in the thickness direction of the housing 10, the tuning cavity 10b may have a width d3, and d1 and d3 may satisfy a relationship of d3≥1.2d1. In a structure in which the width of the tuning cavity 10b changes, the width d3 may take the minimum value among widths of the tuning cavity 10b to ensure that the widths of the tuning cavity 10b and the air guiding gap 10e satisfy the above relationship. If d3<1.2d1, that is, if the air guiding gap 10e changes less or remains the same compared to the width of the tuning cavity 10b, for example, d1=d3, the air might not be compressed when flowing through the air guiding gap 10e, and when the sound generation unit 30 vibrates to generate sound, the air in the mounting cavity 10a and the tuning cavity 10b might not be totally driven, so that there might not be an obvious increase in the vibration mass and no obvious improvement in the low-frequency performance. Therefore, in order to fully increase the vibration mass and reduce the resonance frequency to obtain better low-frequency performance, d3≥1.2d1 may be used. d3 may be 1.5d1, 1.6d1, 2d1, 3d1, and the like.

The width d2 of the mounting cavity 10a and the width d3 of the tuning cavity 10b may be the same or different. Since the width d2 and the width d3 may be both larger than the width d1, an hourglass-like cavity structure may be formed from the mounting cavity 10a to the air guiding gap 10e to the tuning cavity 10b. The air guiding gap 10e may be a narrow channel communicating the two cavities. The air may be compressed when flowing through the air guiding gap 10e, thereby further completely driving the air in the mounting cavity 10a and the tuning cavity 10b, potentially increasing the air load, reducing the resonance frequency, and further improving the low-frequency performance.

Referring to FIGS. 2 to 4, the housing 10 may include a housing body and/or a partition plate 15 provided in the housing body. A space may be formed inside the housing body and may be suitable for accommodating and protecting components such as the sound generation unit 30. The sound outlet hole 101 of the sound outlet part and the vent hole 103 of the pressure relief part may be provided on the housing body. The partition plate 15 may partition an internal space of the housing body into the mounting cavity 10a and the tuning cavity 10b. The sound generation unit 30 may be disposed in the mounting cavity 10a. The sound generation unit 30 may be connected to the partition plate 15, for example, the partition plate 15 may be used as a connecting member of the sound generation unit 30, making the structure more compact. One end of the partition plate 15 and the housing body define the air guiding gap 10e, allowing the rear cavity 10d to communicate with the tuning cavity 10b.

Referring to FIG. 2 again, in a specific example, to facilitate manufacture and assembly, the housing body may include a front housing 11 and a rear housing 13. The front housing 11 and the rear housing 13 may be connected to jointly define the internal space of the housing body. One end of the partition plate 15 may be connected to the front housing 11, and the other end thereof and part of an inner wall of the rear housing 13 may jointly define the air guiding gap 10e. The sound outlet hole 101 may be provided on the front housing 11, and the vent hole 103 may be provided on at least one of the front housing 11 and the rear housing 13. For example, as illustrated in FIG. 2, the vent hole 103 may be enclosed with the front housing 11 and/or the rear housing 13. The vent hole 103 may be provided on the front housing 11 and/or the rear housing 13. For example, in a case where there are multiple vent holes 103, both the front housing 11 and the rear housing 13 may be provided with several vent holes 103.

The sound generation unit 30 may be a moving-coil loudspeaker and may include a basket 31, a magnetic body 33, and/or a vibration component 35. The vibration component 35 may include a diaphragm 353 and/or a voice coil 351. The basket 31 may include an accommodating cavity and/or an opening that communicates with the accommodating cavity. The magnetic body 33 may be disposed in the accommodating cavity and may define a magnetic gap with an inner wall of the accommodating cavity. The diaphragm 353 may cover the opening and may be connected with the basket 31. The voice coil 351 may be located in the accommodating cavity, may be inserted in the magnetic gap, and/or may be connected with the diaphragm 353. When an audio current flows through the voice coil 351, a magnetic field that changes with the audio current may be generated, and the magnetic field may interact with a magnetic field of the magnetic body 33, so that the voice coil 351 vibrates and drives the diaphragm 353 to vibrate to generate sound.

Part of the partition plate 15 may extend into the rear cavity 10d, the basket 31 may be connected with the partition plate 15, and an end of the partition plate 15 away from the front housing 11 may be spaced apart from part of the inner wall of the rear housing 13, which may thereby define the air guiding gap 10e. The diaphragm 353, at least part of the front housing 11, and/or the partition plate 15 may jointly define the front cavity 10c. The at least part of the front housing 11 may include a part of the front housing 11 facing the diaphragm 353, and/or the sound outlet hole 101 may be provided in the part of the front housing 11. The basket 31, at least part of the rear housing 13, and/or the partition plate 15 define the rear cavity 10d, and the at least part of the rear housing 13 may include a part of the rear housing 13 facing the basket 31. The partition plate 15, the front housing 11, and/or the rear housing 13 may further jointly define the tuning cavity 10b located on a side of the partition plate 15 away from the rear cavity 10d.

A side of the end of the partition plate 15, which may be away from the front housing 11, may be connected with sidewalls of the front housing 11 and the rear housing 13, and an tabletop of this end may be spaced apart from an inner bottom wall of the rear housing 13 to define the air guiding gap 10e. For example, the tabletop and some sides of the end of the partition plate 15, which may be away from the front housing 11, may be spaced apart from a part of the inner wall of the rear housing to define the air guiding gap 10e. The air flow areas of the air guiding gaps 10e formed by the above two methods may be smaller than the air flow areas at the connection between the rear cavity 10d and the air guiding gap 10e and the connection between the tuning cavity 10b and the air guiding gap 10e, so that the equivalent mass of air participating in the vibration might be increased and the low-frequency performance may be improved.

The partition plate 15 may be used as at least part of the mounting base of the sound generation unit 30, and the partition plate 15 and the housing body may be spaced apart to define the tuning cavity 10b, increasing the air volume and improving the air load when the sound generation unit 30 vibrates. The rear cavity 10d and the tuning cavity 10b may be effectively partitioned by the partition plate 15, and the narrow air guiding gap 10e may be easily formed between an end of the partition plate 15 and part of the inner wall of the rear housing 13 to connect the rear cavity 10d with the tuning cavity 10b. Meanwhile, the air flowing through the air guiding gap 10e may be compressed, contributing to driving all the air in the rear cavity 10d and the tuning cavity 10b to vibrate, thereby potentially improving the low-frequency performance.

Here, the partition plate 15 and the front housing 11 may have an integrated structure. For example, the partition plate 15 and the front housing 11 may be integrally injection molded, which may provide excellent structural integrity, convenient processing and production, and high efficiency of production. Additionally and/or alternatively, the partition plate 15, the front housing 11, and/or the rear housing 13 may be connected by gluing, snap connection, or the like after being formed separately.

The open-ear headphone 100 may further comprise components such as a circuit board, a battery, an antenna, a charging contact, and/or a magnetic member. Those components might not suitable for contact with water, but since the internal space of the housing 10 may need to communicate with the external environment through the vent hole 103, water may inevitably enter in some cases. In order to improve the reliability of the headphone, the above components might be sealed when disposed in the housing 10.

Referring to FIGS. 2 to 4, in an example, the rear housing 13 may comprise a rear housing body 131 and/or a rear housing sealing cover 133. The rear housing body 131 may be connected with the front housing 11, and the rear housing sealing cover 133 and the rear housing body 131 may be connected and define a first sealing cavity 135 for disposing an object to be sealed 50. The object to be sealed 50 may include the components such as a circuit board, a battery, an antenna, a charging contact, and/or a magnetic member.

At least part of the rear housing sealing cover 133 may form an inner wall surface of the tuning cavity 10b. The tuning cavity 10b may be defined by the partition plate 15 and the rear housing sealing cover 133, and/or defined by the partition plate 15, the rear housing sealing cover 133, and/or part of the front housing 11. In the example illustrated in FIG. 2, the rear housing sealing cover 133 may span the rear cavity 10d and the tuning cavity 10b, and the partition plate 15 may be spaced apart from the rear housing sealing cover 133 to define the air guiding gap 10e. The rear housing sealing cover 133 of the example need not be connected with the sound generation unit 30 to seal the sound generation unit 30. For example, the rear housing sealing cover 133 may be fitted to the rear housing body 131 to seal the object to be sealed 50. In this way, on one hand, when water enters the open-ear headphone 100, the water might have to enter the internal space of the housing 10 through the vent hole 103 and the like and break through the sealing of the rear housing sealing cover 133 before affecting the object to be sealed 50. The entry path of water may be more complex, so that the object to be sealed 50 may be safer, which may be conducive to improving the waterproof grade and reliability of the open-ear headphone 100. On the other hand, the rear housing sealing cover 133 need not seal the sound generation unit 30, but might instead seal the object to be sealed 50. The air in other spaces than the first sealing cavity 135 may participate in vibration when the sound generation unit 30 generates sound. Accordingly, the space utilization may be improved and the air load may be increased, thereby improving the low-frequency performance.

In addition, during assembly, the rear housing sealing cover 133, the object to be sealed 50, and the rear housing body 131 may be assembled and then fit-connected with the front housing 11 and the sound generation unit 30. For instance, in the production process, for the open-ear headphone 100 of a specific model, the rear housing sealing cover 133, the rear housing body 131, and/or the object to be sealed 50 therein may be integrated in the assembly process as a whole, thereby reducing assembly difficulty and assembly steps and improving the efficiency of production.

Further, as illustrated in FIG. 2, the front housing 11 may include a front housing body 111 and/or a front housing sealing cover 113. The front housing body 111 may be connected with the rear housing body 131, and the sound outlet hole 101 may be provided on the front housing body 111. The front housing sealing cover 113 and the front housing body 111 may be connected and may define a second sealing cavity 115 for disposing the object to be sealed 50. Similarly, the object to be sealed 50 may comprise components such as a circuit board, a battery, an antenna, a charging contact, and/or a magnetic member. The front housing sealing cover 113 and the second sealing cavity 115 may be provided to sufficiently seal the object to be sealed 50, thereby further improving the reliability of the open-ear headphone 100. Here, the partition plate 15 may be connected with the front housing body 111, and the front housing sealing cover 113 may be disposed on a side of the partition plate 15 away from the sound generation unit 30, so that the front housing sealing cover 113, the rear housing sealing cover 133 and/or the partition plate 15 may define the tuning cavity 10b.

The front housing sealing cover 113 and the rear housing sealing cover 133 may be structural members provided for the object to be sealed 50. Additionally and/or alternatively, housings of some components having a waterproof and sealing function may also be used as the front housing sealing cover 113 or the rear housing sealing cover 133 to form at least part of a wall surface of the tuning cavity 10b. For example, some magnetic members are not affected by water, and such magnetic member may be directly connected with the front housing body 111 and/or the rear housing body 131, and a surface of the magnetic member may be used as the front housing sealing cover 113 and/or the rear housing sealing cover 133.

A formation mode of the air guiding gap 10e might not be limited to the examples described above. For example, the partition plate 15 may also connect the front housing 11 with the rear housing 13, and a through hole may be provided on the partition plate 15 to connect the rear cavity 10d with the tuning cavity 10b, thereby forming the air guiding gap 10e.

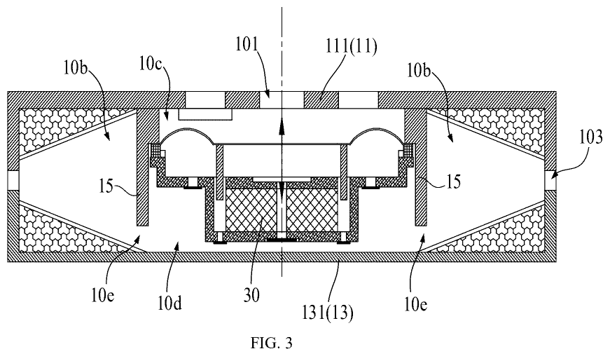

Referring to FIGS. 2 and 3, in some examples of the present disclosure, the tuning cavity 10b may be positioned at a side of the mounting cavity 10a surrounding an axial direction of the sound generation unit 30, which may be not only convenient for disposing a sealing cover, but also easy for construction, and does not affect a thickness of the front-end portion 100a of the open-ear headphone 100.

For example, the housing 10 may be provided with at least two tuning cavities 10b, and the at least two tuning cavities 10b may be respectively located at least two sides in a circumferential direction of the mounting cavity 10a. The housing 10 may be also provided with at least two air guiding gaps 10e and at least two pressure relief parts, one of the air guiding gaps 10e may connect one of the tuning cavity 10b and the rear cavity 10d, and each of the pressure relief parts may correspond to one of the tuning cavities 10b. The housing 10 may include two partition plates 15. The two partition plates 15 may be spaced apart and partition the internal space of the housing 10 into two tuning cavities 10b and one mounting cavity 10a. Each of the partition plates 15 may be spaced apart from the rear housing 13 to form one air guiding gap 10e, and the sound generation unit 30 may be connected with the two partition plates 15. By providing at least two tuning cavities 10b, the volume of air participating in vibration may be further increased, the vibration mass may be increased, and the low-frequency sound performance may be improved. Further, at least two tuning cavities 10b may be symmetrically disposed with respect to the mounting cavity 10a, so that the open-ear headphone 100 can have a symmetrical and aesthetic shape.

The tuning cavity 10b may also be disposed around the mounting cavity 10a, and the partition plate 15 may also be annular, so as to define the annular air guiding gap 10e with the housing body. Along a circumferential direction of the mounting cavity 10a, the air guiding gap 10e may be continuous or intermittent.

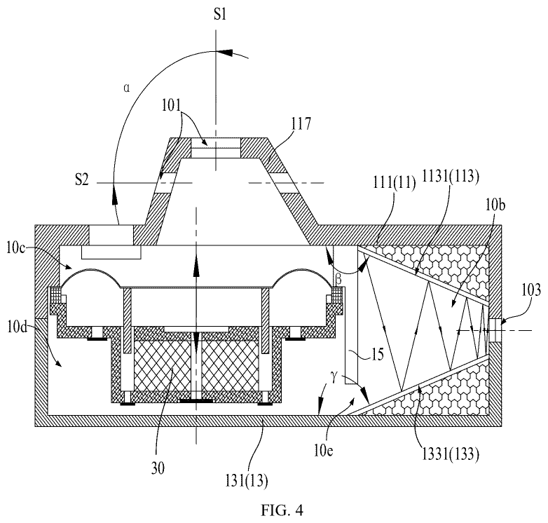

Referring to FIG. 4, in some examples, the air flow area of the tuning cavity 10b may decrease in a direction in which air flows from the air guiding gap 10e to the vent hole 103. In the example illustrated in FIG. 4, the vent hole 103 may be provided on a circumferential side of the housing 10, and the air guiding gap 10e faces the vent hole 10e in a direction perpendicular to the thickness direction of the housing 10. The direction in which the air flows from the air guiding gap 10e to the vent hole 103 may be a direction perpendicular to the thickness direction of the housing 10. In this way, sound waves propagating toward the vent hole 103 may be continuously reflected in the path, forming an acoustic black hole. During this process, the speed of the sound waves may gradually decrease, thereby potentially reducing the propagation of sound through the vent hole 103, reducing sound leakage of the open-ear headphone 100, and improving the user experience.

In the example illustrated in FIG. 4, the thickness direction of the housing 10 may be substantially the same as the axial direction of the sound generation unit 30. In the thickness direction of the housing 10, the tuning cavity 10b may have a first wall surface 1131 and a second wall surface 1331, which may face each other. The first wall surface 1131 may be at least part of the surface of the front housing sealing cover 113, and the second wall surface 1331 may be at least part of the surface of the rear housing sealing cover 133. Here, along a direction approaching the vent hole 103, a distance between the first wall surface 1131 and the second wall surface 1331 may gradually decrease. In this way, the sound waves in the tuning cavity 10b may be continuously reflected by the first wall surface 1131 and the second wall surface 1331 in the propagation process of approaching the vent hole 103, thereby potentially achieving the purpose of reducing the sound leakage of the vent hole 103.

At least one of the first wall surface 1131 and the second wall surface 1331 may be inclined. For example, assuming that the housing 10 may be placed horizontally and the thickness direction of the housing 10 may be along a vertical direction, one of the first wall surface 1131 and the second wall surface 1331 may be provided horizontally, and the other can be inclined upward or downward toward the vent hole 103 along the direction of approaching the vent hole 103, thereby gradually reducing the distance between the first wall surface 1131 and the second wall surface 1331 along the direction of approaching the vent hole 103; or, as illustrated in FIG. 4, the first wall surface 1131 and the second wall surface 1331 may be both inclined, that is, along the direction of approaching the vent hole 103, the first wall surface 1131 may gradually incline downward, and the second wall surface 1331 may gradually incline upward, so that the distance between the first wall surface 1131 and the second wall surface 1331 may gradually decrease.

When the open-ear headphone 100 may be placed horizontally, at least part of the front housing body 111 and the rear housing body 131 may also be placed horizontally, and at least one of the first wall surface 1131 and the second wall surface 1331 may form an obtuse angle with the horizontal direction. When an included angle between the first wall surface 1131 and the part of the front housing body 111 may be β and an included angle between the second wall surface 1331 and the part of the rear housing body 131 may be γ, a relationship may be satisfied: 90°<β<180°, and 90°<γ<180°. If β or γ are equal to or less than 90 degrees, the first wall surface 1131 or the second wall surface 1331 might not be able to form the inner wall of the tuning cavity 10b, and if β or γ may be equal to or greater than 90 degrees, it might not be easy to construct a structural form in which the distance between the first wall surface 1131 and the second wall surface 1331 gradually decreases. β and γ are optionally 120°, 150°, 160°, and the like.

Referring to FIGS. 2 to 4, in some examples, the pressure relief part may be located on the circumferential side of the housing 10 to be away from the sound generation unit 30, thereby potentially increasing the air load improve the low-frequency sound performance and facilitating sufficient reflection of the sound waves to reduce sound leakage.

Here, a diameter of the vent hole 103 may be r, and in the thickness direction of the housing 10, a relationship of d2≥1.2r may be satisfied. If d2<1.2r, the size of the vent hole 103 may be too large, which may be not only not conducive to maintaining the pressure in the rear cavity 10d and the tuning cavity 10b, resulting in poor sound output effect. This size may also cause more serious sound leakage due to the excessive size. Therefore, in order to ensure the sound output effect and reduce the sound leakage, the present example may define d2≥1.2r. For example, d2 can be 1.8r, 2r, 3r, and the like.

Further, in the thickness direction of the housing 10, a relationship of d3≥1.2r may be also satisfied, which can further ensure the sound output effect and reduce the sound leakage. For example, d2 can be 1.8r, 2r, 3r, and the like.

Referring to FIGS. 3 and 4, in some examples, the sound outlet part may include at least two sound outlet holes 101, and central axes of the at least two sound outlet holes 101 may be arranged in parallel. For consumers with large ears, in the wearing state, it may be inevitable that the sound outlet holes 101 move in the direction toward the top of the head relative to the external ear canal, and some of the sound outlet holes 101 may be blocked by the ear, resulting in smaller sounds heard by the user and affecting the user experience. In some examples, the at least two sound outlet holes 101 may be oriented differently. In this way, when one of the sound outlet holes 101 may be blocked by the user's ear, at least the other sound outlet hole 101 may be oriented differently from the blocked sound outlet hole 101 and might not be blocked by the user's ear, so that the sound waves can be transmitted to the user's external ear canal from the unblocked sound outlet hole 101, which may guarantee the user's listening experience and improving the robustness of the open-ear headphone 100. Accordingly, the compatibility of the open-ear headphone 100 may be good, and different consumers may enjoy the same magnitude of sound as much as possible.

Referring to FIG. 4, in a specific example, at least part of the front housing 11 may be humped up in a direction away from the sound generation unit 30 to form a sound outlet boss 117, at least one sound outlet hole 101 may be provided on a tabletop of the sound outlet boss 117, and at least one sound outlet hole 101 may be provided on a side surface of the sound outlet boss 117. The sound outlet boss 117 humped can make the sound outlet part closer to the user's external ear canal, potentially improving the sound pressure level, and making it convenient for the user to hear sounds. As illustrated in FIG. 4, the sound outlet boss 117 can be a hump of a truncated cone shape, and the sound outlet hole 101 positioned on the tabletop of the sound outlet boss 117 may have a central axis S1 and the sound outlet hole 101 positioned on the side surface of the sound outlet boss 117 has a central axis S2. In the example illustrated in FIG. 4, an included angle a formed by the central axis S1 and the central axis S2 may be 90 degrees, that is, orientations of the two sound outlet holes 101 may be provided at 90 degrees. In this way, when the sound outlet hole 101 positioned on the tabletop of the sound outlet boss 117 may be blocked, it may nonetheless be guaranteed to the greatest extent that the sound outlet hole 101 positioned on the side surface of the sound outlet boss 117 might not be blocked, allowing the user to hear the sounds clearly.

The sound outlet boss 117 may have a prismatic or cylindrical shape, and the included angle α formed by the central axes of the two sound outlet holes 101 need not be limited. The number of the sound outlet holes 101 need not be limited, and the housing 10 may be provided with three or more sound outlet holes 101. Taking three sound outlet holes 101 as an example, one of the sound outlet holes 101 may be positioned on the tabletop of the sound outlet boss 117, the other two sound outlet holes 101 may be positioned on the side surface of the sound outlet boss 117, and axes of the two sound outlet holes 101 positioned on the side surface of the sound outlet boss 117 may be provided in parallel or at an included angle.

Sounds collected in a working condition 1 where a single sound outlet hole 101 or multiple sound outlet holes 101 were provided and central axes thereof were parallel and sounds collected in a working condition 2 where at least two sound outlet holes 101 were provided and central axes thereof were provided at an included angle were experimentally compared in volume by an experiment to obtain a sound gain (dB). A higher sound gain indicates that the sound that the user can hear in working condition 2 was greater than the sound that the user can hear in working condition 1. The sound data when the open-ear headphone 100 moves upward by 3 mm, 6 mm, 9 mm, and 12 mm from a starting position where at least two sound outlet holes 101 were completely unblocked was collected in the experiment as follows:

| Wearing positions | Sound gains (dB) |
|---|---|
| 3 mm | 1.75 |
| 6 mm | 3.3 |
| 9 mm | 5 |
| 12 mm | 5 |

When the sound outlet hole 101 might be blocked, a user can hear a larger sound in the working condition 2, and as more sound outlet holes 101 are blocked, the sound gain in the second working condition might be higher than that in the working condition 1. Therefore, the arrangements described in the present disclosure can reduce the sound loss caused by the misalignment of the open-ear headphone 100 and blocking of some of the sound outlet holes 101, and improve the robustness.

The same or similar reference numerals in the drawings of the example may correspond to the same or similar components. In the description of the present disclosure, it should be understood that if the terms “up,” “down,” “left,” “right,” and the like indicate directions or positional relationships as an example for the convenience of describing the disclosure and simplifying the description, and these terms do not indicate or imply that the device or element referred to must have a specific direction and/or be constructed and operated in a specific direction. The terms describing the positional relationship in the drawings are only used for illustrative purposes and are not limitations on the present disclosure.

The above description provides various examples of the present disclosure and is not intended to limit the present disclosure. Any modifications, equivalent substitutions, and/or improvements made within the spirit and principles of the present disclosure are included in the protection scope of the present disclosure.

What is claimed is:

1. An open-ear headphone comprising:
a housing comprising:
a mounting cavity,
a tuning cavity provided next to the mounting cavity,
a sound outlet hole, and
a vent hole; and
a sound generation unit provided in the mounting cavity and partitioning the mounting cavity into a front cavity and a rear cavity, wherein:
the sound outlet hole communicates with the front cavity,
the vent hole communicates with the tuning cavity,
an air guiding gap is further provided in the housing and connects the rear cavity and the tuning cavity, and
a flow area formed at a part where the rear cavity and the air guiding gap are connected and a flow area formed at a part where the tuning cavity and the air guiding gap are connected are both larger than a flow area formed at the air guiding gap.

2. The open-ear headphone according to claim 1, wherein:
the housing further comprises a housing body and a partition plate provided in the housing body,
the housing body is provided with the sound outlet hole and the vent hole,
the partition plate partitions an internal space of the housing body into the mounting cavity and the tuning cavity, and
one end of the partition plate and the housing body define the air guiding gap.

3. The open-ear headphone according to claim 1, wherein:
the housing further comprises a housing body and a partition plate, wherein the housing body comprises:
a front housing provided with the sound outlet hole; and
a rear housing connected with the front housing and defining an internal space of the housing body together with the front housing, and
one end of the partition plate is connected with the front housing, another end of the partition plate away from the front housing and part of an inner wall of the rear housing together define the air guiding gap, and the vent hole is provided on at least one of the front housing and the rear housing.

4. The open-ear headphone according to claim 1, wherein:
the housing further comprises a housing body and a partition plate, wherein the housing body comprises:
a front housing provided with the sound outlet hole; and
a rear housing connected with the front housing and defining an internal space of the housing body together with the front housing, and
wherein the rear housing comprises:
a rear housing body connected with the front housing; and
a rear housing sealing cover connected with the rear housing body and defining a first sealing cavity, wherein:
the first sealing cavity is configured to seal an object to be sealed together with the rear housing body,
at least the rear housing sealing cover and the partition plate define the tuning cavity, and
one end of the partition plate away from the front housing and the rear housing sealing cover or part of an inner wall of the rear housing body define the air guiding gap.

5. The open-ear headphone according to claim 1, wherein:
the housing further comprises a housing body and a partition plate, wherein the housing body comprises:
a front housing provided with the sound outlet hole; and
a rear housing connected with the front housing and defining internal space of the housing body together with the front housing, and
wherein the front housing comprises:
a front housing body connected with a rear housing body of the rear housing and provided with the sound outlet hole; and
a front housing sealing cover connected with the front housing body and defining a second sealing cavity, wherein:
the second sealing cavity is configured to dispose an object to be sealed, together with the front housing body,
the partition plate is connected with the front housing body, and
at least the front housing sealing cover, the rear housing sealing cover, and the partition plate define the tuning cavity.

6. The open-ear headphone according to claim 1, wherein one or more of:
in a thickness direction of the housing, the air guiding gap has a width d1, and the mounting cavity has a width d2, which satisfy a relationship of d2≥1.2d1;
in a thickness direction of the housing, the air guiding gap has a width d1, the tuning cavity has a width d3, which satisfy a relationship of d3≥1.2d1; or
the housing is provided with at least two tuning cavities respectively positioned at least two sides in a circumferential direction of the mounting cavity.

7. The open-ear headphone according to claim 1, wherein an air flow area of the tuning cavity decreases in a flow direction of air from the air guiding gap to the vent hole.

8. The open-ear headphone according to claim 1, wherein in a thickness direction of the housing, the tuning cavity has a first wall surface and a second wall surface facing each other, and a distance between the first wall surface and the second wall surface gradually decreases in a direction of approaching the vent hole.

9. The open-ear headphone according to claim 1, wherein one or more of:
the vent hole is positioned on a circumferential side of the housing,
in a thickness direction of the housing, the vent hole has a diameter r, the mounting cavity has a width d2, which satisfy a relationship of d2≥1.2r; or
in a thickness direction of the housing, the vent hole has a diameter r, the tuning cavity has a width d3, which satisfy a relationship of d3≥1.2r.

10. The open-ear headphone according to claim 1, wherein the housing is provided with at least two sound outlet holes having at least two different orientations.

11. The open-ear headphone according to claim 1, wherein:
at least part of the housing is humped up in a direction away from the sound generation unit to form a sound outlet boss,
the housing is provided with at least two sound outlet holes,
at least one of the sound outlet holes is provided on a tabletop of the sound outlet boss, and
at least one of the sound outlet holes is provided on a side surface of the sound outlet boss.

12. An open-ear headphone comprising:
a housing; and
a sound generation unit provided in a mounting cavity of the housing and partitioning the mounting cavity into a front cavity and a rear cavity, wherein:
an air guiding gap in the housing connects the rear cavity and a tuning cavity provided next to the mounting cavity, and
a flow area formed at a part where the rear cavity and the air guiding gap are connected and a flow area formed at a part where the tuning cavity and the air guiding gap are connected are both larger than a flow area formed at the air guiding gap.

13. The open-ear headphone according to claim 12, wherein:
the housing further comprises a housing body and a partition plate provided in the housing body,
the partition plate partitions an internal space of the housing body into the mounting cavity and the tuning cavity, and
one end of the partition plate and the housing body define the air guiding gap.

14. The open-ear headphone according to claim 12, wherein:
the housing further comprises a housing body and a partition plate, wherein the housing body comprises:
a front housing; and
a rear housing connected with the front housing and defining an internal space of the housing body together with the front housing, and
one end of the partition plate is connected with the front housing, another end of the partition plate away from the front housing and part of an inner wall of the rear housing together define the air guiding gap, and a vent hole is provided on at least one of the front housing and the rear housing.

15. The open-ear headphone according to claim 12, wherein:
the housing further comprises a housing body and a partition plate, wherein the housing body comprises:
a front housing; and
a rear housing connected with the front housing and defining an internal space of the housing body together with the front housing, and
wherein the rear housing comprises:
a rear housing body connected with the front housing; and
a rear housing sealing cover connected with the rear housing body and defining a first sealing cavity, wherein:
the first sealing cavity is configured to seal an object to be sealed together with the rear housing body,
at least the rear housing sealing cover and the partition plate define the tuning cavity, and
one end of the partition plate away from the front housing and the rear housing sealing cover or part of an inner wall of the rear housing body define the air guiding gap.

16. The open-ear headphone according to claim 12, wherein:
the housing further comprises a housing body and a partition plate, wherein the housing body comprises:
a front housing; and
a rear housing connected with the front housing and defining internal space of the housing body together with the front housing, and
wherein the front housing comprises:
a front housing body connected with a rear housing body of the rear housing; and
a front housing sealing cover connected with the front housing body and defining a second sealing cavity, wherein:
the second sealing cavity is configured to dispose an object to be sealed, together with the front housing body,
the partition plate is connected with the front housing body, and
at least the front housing sealing cover, the rear housing sealing cover, and the partition plate define the tuning cavity.

17. The open-ear headphone according to claim 12, wherein one or more of:
in a thickness direction of the housing, the air guiding gap has a width d1, and the mounting cavity has a width d2, which satisfy a relationship of d2≥1.2d1;
in a thickness direction of the housing, the air guiding gap has a width d1, the tuning cavity has a width d3, which satisfy a relationship of d3≥1.2d1; or
the housing is provided with at least two tuning cavities respectively positioned at least two sides in a circumferential direction of the mounting cavity.

18. The open-ear headphone according to claim 12, wherein an air flow area of the tuning cavity decreases in a flow direction of air from the air guiding gap to a vent hole.

19. A system comprising:
an open-ear headphone comprising:
a housing; and
a sound generation unit provided in a mounting cavity of the housing and partitioning the mounting cavity into a front cavity and a rear cavity, wherein:
an air guiding gap in the housing connects the rear cavity and a tuning cavity provided next to the mounting cavity, and
a flow area formed at a part where the rear cavity and the air guiding gap are connected and a flow area formed at a part where the tuning cavity and the air guiding gap are connected are both larger than a flow area formed at the air guiding gap; and
a computing device configured to cause the sound generation unit to output one or more sounds via the open-ear headphone.

20. The open-ear headphone according to claim 19, wherein:
the housing further comprises a housing body and a partition plate provided in the housing body,
the partition plate partitions an internal space of the housing body into the mounting cavity and the tuning cavity, and
one end of the partition plate and the housing body define the air guiding gap.
